(19) United States
(12) Patent Application Publication
(10) Pub. No.: US 2026/0119115 A1
(43) Pub. Date: Apr. 30, 2026

(54) METHODS AND SYSTEMS FOR MANAGING AUDIO OUTPUTS

(71) Applicant: Comcast Cable Communications, LLC, Philadelphia, PA (US)

(72) Inventors: Matthew Ebersviller, Centennial, CO (US); Antonio Lucio, Centennial, CO (US); Andrew Arkis, Centennial, CO (US)

(21) Appl. No.: 18/933,284

(22) Filed: Oct. 31, 2024

(51) Int. Cl. G06F 3/16; H04N 21/81

(52) U.S. Cl. CPC G06F 3/165; H04N 21/8106

(57) ABSTRACT

Methods, apparatuses, and systems are described for providing secondary audio content of a content item via a plurality of audio output devices. The content item may include first audio content and second audio content. A media device may output the first audio content via one or more audio output devices of a plurality of audio output devices based on an audio playback profile. In addition, the media device may output the second audio content via one or more other audio output devices of the plurality of audio output devices that are not being used to output the first audio content and/or via the one or more audio output devices that are being used to output the first audio content but are being underutilized for outputting the first audio content.

### BACKGROUND

Current audio playback systems include the use of multi-channel sound systems, such as “X.Y” sound systems for outputting audio via multiple speakers. In an X.Y. sound system, the “X.” represents the number of different loudspeakers used for detectable/directionable audio signals and the “Y” is related to the number of sub-woofer loudspeakers. Such multi-channel sound systems include such multi-channel speaker formats as (two channel) stereo (2.0), (four channel) Quattro (4.0), (four channel) LCRS, (six channel) 5.1, and (eight channel) 7.1 sound systems. The most popular format, the 5.1 sound system uses left, center, and right front speakers, and left and right rear surround speakers, as well as a sub-woofer (i.e., the 0.1). Conventional descriptive audio services are implemented by outputting descriptive audio via left/right stereo speakers. However, this can clash with the primary audio associated with the content item being output on the same audio speakers, causing difficulty in hearing the descriptive audio over the primary audio.

### SUMMARY

It is to be understood that both the following general description and the following detailed description are examples and explanatory only and are not restrictive. Methods, systems, and apparatuses for providing secondary audio content of a content item via multiple audio output devices are disclosed.

A content item associated with an audio playback profile may be received by a media device. The content item may include first audio content and second audio content. The media device may output the first audio content via one or more audio output devices of a plurality of audio output devices based on the audio playback profile. In addition, the media device may output the second audio content via one or more other audio output devices of the plurality of audio output devices that are not being used to output the first audio content and/or via the one or more audio output devices that are being used to output the first audio content but are being underutilized for outputting the first audio content.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows an example system for outputting audio content;

FIG. 2 shows an example configuration of audio output devices;

FIGS. 3A-3C show example scenarios of an example configuration of audio output devices;

FIG. 4 shows a flowchart of an example method;

FIG. 5 shows a flowchart of an example method;

FIG. 6 shows a flowchart of an example method;

FIG. 7 shows a flowchart of an example method;

FIG. 8 shows a flowchart of an example method; and

FIG. 9 shows a block diagram of an example system and computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

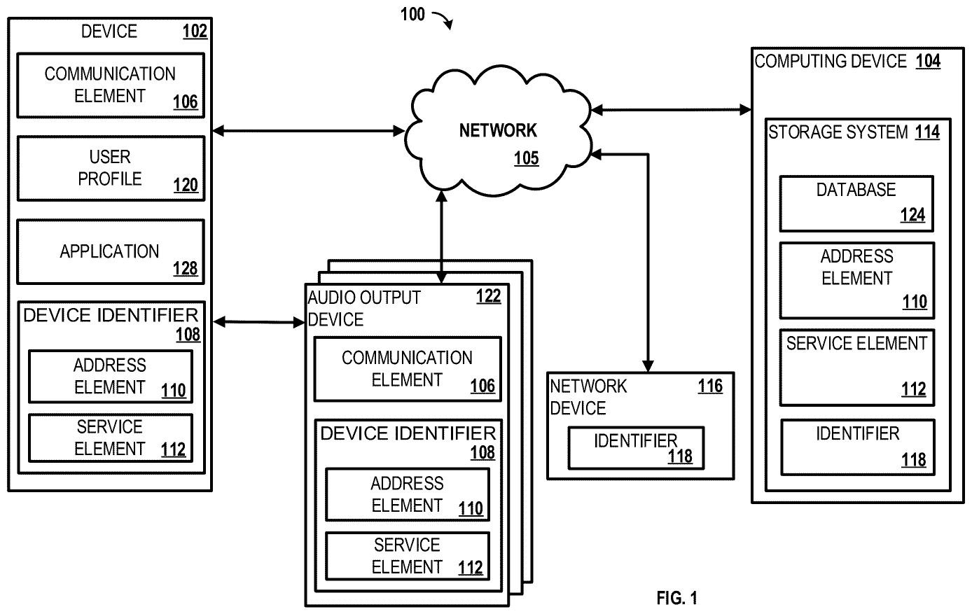

FIG. 1 shows an example system 100 for providing audio content via a plurality of audio output devices. For example, the system 100 may be configured to receive a content item associated with an audio playback profile, wherein the content item may comprise first audio content and second audio content. The first audio content may be output via one or more audio output devices of a plurality of audio output devices based on the audio playback profile. The second audio content may be output via one or more other audio output devices of the plurality of audio output devices that are not being used to output the first audio content and/or via the one or more audio output devices that are being used to output the first audio content but are being underutilized for outputting the first audio content. The network and system 100 may be configured to provide services, such as network-related services, to a device (e.g., device 102, audio output devices 122, etc.). The system 100 may comprise a device 102 and a plurality of audio output devices 122 in communication with a network device 116, such as a wireless access point (e.g., gateway device) and/or a LTE back-up device, for example. The computing device 104 may be disposed locally or remotely relative to the device 102 and/or the audio output devices 122. The network device 116 may facilitate access to the network 105 for the device 102, the audio output devices 122, and/or the computing device 104. For example, the device 102, the audio output devices 122, and the computing device 104 may be in communication via a private and/or public network 105 such as the Internet or a local area network (LAN) via the network device 116. In an example, the audio output devices 122 may be in communication with the device 102 via short range communication (e.g., wired, Bluetooth, near-field communication (NFC), etc.). The network device 116 may be in communication with a computing device 104 such as a centralized device or a server, for example. Other forms of communications can be used such as wired and wireless telecommunication channels.

The device 102 may comprise an electronic device such as a computer, a smartphone, a laptop, a tablet, a set top box, a display device, a television, and the like, or other device capable of communicating with the network device 116 and the audio output devices 122 may comprise one or more speakers (e.g., wired/wireless speakers capable of outputting audio received from the device 102). As an example, the device 102 and/or the audio output devices 122 may comprise a communication element 106 for offering an interface to a user to interact with the device 102, the audio output devices 122, and/or the computing device 104. The communication element 106 can be any interface for presenting and/or receiving information to/from the user, such as media content. An example interface may be a communication interface such as a web browser (e.g., Internet Explorer®, Mozilla Firefox®, Google Chrome®, Safari®, or the like). Other software, hardware, and/or interfaces can be used to facilitate communication between the user and one or more of the device 102, the audio output devices 122, and the network device 116. As an example, the communication element 106 can request or query various files from a local source and/or a remote source. As an example, the communication element 106 can transmit data to a local or remote device such as the network device 116 or the computing device 104 via the network device 116.

The device 102 and/or the audio output devices 122 may be associated with a user identifier or a device identifier 108. As an example, the device identifier 108 may be any identifier, token, character, string, or the like, for differentiating one user or user device (e.g., user device 102, audio output devices 122, etc.) from another user or user device. The device identifier 108 may identify a user or user device as belonging to a particular class of users or user devices. As an example, the device identifier 108 may comprise information relating to the user device such as a manufacturer, a model or type of device, a service provider associated with the device 102 and/or the audio output devices 122, a state of the device 102 and/or the audio output devices 122, a locator, and/or a label or classifier. Other information can be represented by the device identifier 108.

The device identifier 108 may comprise address element 110 and service elements 112. The address element 110 may comprise or make available an internet protocol address, a network address, a media access control (MAC) address, an Internet address, or the like. As an example, the address element 110 may be relied upon to establish a communication session between the device 102, the audio output devices 122, and the network device 116 or other devices and/or networks. As an example, the address element 110 may be used as an identifier or locator of the user device 102 and/or the audio output devices 122. The address element 110 may be persistent for a particular network.

The service element 112 may comprise identification of the service providers associated with the device 102 and the audio output devices 122 and/or with the class of the device 102 and the audio output devices 122. The class of the device 102 and/or the audio output devices 122 may be related to a type of device (e.g., display device, audio output device, etc.), a capability of a device, a type of service being offered, and/or a level of service (e.g., a business class, a service tier, a service package, etc.). As an example, the service element 112 may comprise information relating to or made available by a communication service provider (e.g., an Internet service provider) that is offering or enabling data flow such as communication services to the device 102 and/or the audio output devices 122. As an example, the service element 112 may comprise information relating to a preferred service provider for one or more particular services relating to the device 102 and/or the audio output devices 122. The address element 110 may be used to identify or retrieve data from the service element 112, or vice-versa. As an example, one or more of the address element 110 and the service element 112 can be stored remotely from the device 102 and/or the audio output devices 122 and retrieved by one or more devices such as the device 102, the audio output devices 122 and the computing device 104. Other information can be represented by the service element 112.

The device 102 may be configured to receive a content item associated with an audio playback profile. In an example, the device 102 may include an application 128 (e.g., content streaming service, video playback application, etc.) that may be partially or fully executed in a device environment of the device 102. The application 128 may cause one or more of the audio output devices 122 to output audio content associated with the content item (e.g., video content) being output at the device 102. In an example, the content item may comprise first audio content and second audio content associated with a video content item. For example, the first audio content may comprise primary audio content of the content item and the second audio content may comprise one or more of secondary audio, supplemental audio, language audio, or descriptive audio of the content item. The device 102 may cause one or more audio output devices 122 of a plurality of audio output devices 122 to output the first audio content based on the audio playback profile. The audio playback profile may comprise one or more audio output device configurations for outputting the first audio content. As an example, the one or more audio output device configurations may be associated with multi-channel speaker formats such as (two channel) stereo (2.0), (four channel) Quattro (4.0), (four channel) LCRS, (six channel) 5.1, and (eight channel) 7.1 sound systems, including sound systems that include ceiling speakers, soundbars that bounce sound off of the ceiling (e.g., sound reverberation), etc. For example, the device 102 may cause left, center, and right front speakers, and left and right rear speakers, as well as a sub-woofer to output the first audio content based on an audio playback profile indicating a six channel 5.1 multi-channel speaker format. For example, the plurality of audio output devices 122 may comprise a plurality of speakers at one or more locations in a vicinity of the device 102. The device 102 may cause one or more remaining audio output devices 122 of the plurality of audio output devices 122 to output the second audio content. For example the one or more remaining audio output devices 122 comprise one or more audio output devices 122 of the plurality of audio output devices 122 not outputting the first audio content. As an example, in a six channel 5.1 multi-channel speaker format, one or more of the speakers may not output audio content (e.g., first audio content), such as the rear speakers when there is no rear audio to be output to a user of the device 102. The device 102 may determine that the rear audio output devices 122 are not outputting the first audio content (e.g., during a scene or time point in the content item) and cause the rear audio output devices 122 to output the second audio content. In an example, the device 102 may cause the one or more remaining audio output devices 122 of the plurality of audio output devices 122 to output the second audio content based on one or more locations of one or more users in a vicinity of the device 102. For example, the device 102 may determine that the rear audio output devices 122 are not outputting the first audio content (e.g., during a scene or time point in the content item). The device 102 may determine (e.g., via one or more sensor devices) one or more locations of one or more users in the vicinity of the device 102. For example, the device 102 may determine that a single user in the vicinity of the device 102 is located closer to the rear right audio output device 122 and cause the rear right audio output device 122 to output the second audio content. In an example, the device 102 may balance the audio output (e.g., volume level) between the rear audio output devices 122 based on the user's location. For example, the device 102 may cause the rear right audio output device 122 to output the second audio content at a lower volume level than the second audio content output by the rear left audio output device 122 based on the user being located closer to the rear right audio output device 122.

As an example, the device 102 may cause any audio output device 122 of the plurality of audio output devices 122 to output the second audio content when not in use. For example, different audio output devices 122 may output the first audio content depending on a scene/segment of the content item. The device 102 may determine when an audio output device 122 is not in use, such as based on a scene/segment of the content item. For example, a scene/segment of a content item may be associated with audio content (e.g., the first audio content) being output from one or more of the front audio output devices 122 while the rear audio output devices 122 are unused. Based on the rear audio output devices 122 being unused, the device 102 may cause the rear audio output devices 122 to output the second audio content.

As an example, the device 102 may cause at least one audio output device 122 of one or more audio output devices 122 of the plurality of audio output devices 122 to output the second audio content based on a state of audio output of the one or more audio output devices 122. For example, the device 102 may cause the one more audio output devices 122 to output the first audio content based on an audio playback profile of a content item. However, at least one audio output device 122 of the one or more audio output devices 122 may be underutilized based on the output of the first audio content. For example, the state of audio output may be associated with one or more of a frequency of use of an audio output device 122, a volume level of the first audio content being output, or an audio content type of the first audio content being output. The audio content type may comprise one or more of voice audio, background audio, foreground audio, or music audio. Based on the state of audio output associated with the at least one audio output device 122 indicating that the at least one audio output device 122 is being underutilized, the device 102 may cause the at least one audio output device 122 to output the second audio content.

As an example, the device 102 may override the audio playback profile to cause one or more audio output devices 122 to output the second audio content based on a user profile 120 associated with the device 102 regardless of whether the one or more audio devices 122 are outputting the first audio content. For example, the device 102 may further include, or store, a user profile 120. The user profile 120 may cause specific audio output devices 122 to output the second audio content regardless of whether the audio output device 122 is outputting the first audio content (e.g., based on one or more user preferences). For example, the rear audio output devices 122 may output the first audio content during certain scenes/segments of the content item. However, the user profile may require that the rear audio output devices 122 (e.g., since the rear speakers are usually the closest to the user) always output the second audio content. The device 102 may cause the rear audio output devices 122 to output both the first audio content and the second audio content based on the user profile. In an example, the device 102 may balance the audio output (e.g., volume of the first audio content and/or the second audio content) at the rear audio output devices 122. For example, the device 102 may cause the rear audio output devices 122 to output the first audio content at a lower volume level than the second audio content.

As an example, the device 102 may cause one or more audio output devices 122 to output the second audio content based on one or more time points in a content item. For example, the content item may comprise first audio content and second audio content associated with the one or more time points in the content item. The device 102 may determine a plurality of audio output devices 122 for outputting the first audio content and the second audio content. For example, the device 102 may be in communication with front audio output devices 122 (e.g., a center, a front right speaker front left speaker, a sub-woofer, a ceiling speaker, a reverberating speaker, etc.) and rear audio output devices 122 (e.g., a rear right speaker, a rear left speaker, etc.). One or more first audio output devices 122 of the plurality of audio output devices 122 may output the first audio content at each time point of the one or more time points (e.g., different audio output devices 122 output the first audio content depending on the time point in the content item such as during different scenes/segments of the content item). Based on the one or more first audio output devices 122 outputting the first audio content at each time point, the device 102 may cause one or more second audio output devices 122 of the plurality of audio output devices 122 to output the second audio content at each time point. In an example, based on the one or more second audio output devices 122 not outputting the first audio content at each time point (e.g., one or more remaining audio output devices 122 of the plurality of audio output devices 122 not outputting the first audio content), the device 102 may cause the one or more second audio output devices 122 to output the second audio content at each time point. In an example, the device 102 may determine a state of each first audio output device 122 of the one or more first audio output devices 122 outputting the first audio content at each time point. The device 102 may also cause at least one first audio output device 122 of the one or more first audio output devices 122 that is being underutilized to output the second audio content. For example, the state of each first audio output device 122 may be associated with one or more of a frequency of use of an audio output device 122, a volume level of the first audio content being output, or an audio content type of the first audio content being output. For example, the one or more second audio output devices 122 the device 102 causes to output the second audio content may further include the at least one first audio output device 122.

A network device 116 may be in communication with a network, such as network 105. The network device 116 may be configured to allow one or more wireless devices to connect to a wired and/or wireless network using Wi-Fi, Bluetooth®, Zigbee®, or any desired method or standard. As an example, one or more of the network device 116 may be configured to facilitate the connection of a device, such as the device 102 and/or the audio output devices 122, to the network 105. The network device 116 may be configured as a wireless access point (WAP) to provide access to a wide area network (e.g., the Internet). For example, the network device 116 may be configured to access the wide area network via a computing device (e.g., computing device 104, server, headend, Internet service provider, etc.). The network device 116 may be configured to perform one or more gateway functions in order to provide the access to the wide area network. The one or more gateway functions may comprise one or more of network traffic routing, dynamic host configuration protocol (DHCP) management, VOIP functions, or IP streaming functions.

The network device 116 may comprise an identifier 118. As an example, the identifier 118 can be or relate to an Internet Protocol (IP) Address IPV4/IPV6 or a media access control address (MAC address) or the like. As a further example, the identifier 118 may be a unique identifier for facilitating communications on the physical network segment. The network device 116 may comprise an identifier 118 that is distinct. As an example, the identifier 118 may be associated with a physical location of the network device 116.

The computing device 104 may comprise a server, or a centralized device, for communicating with the network device 116, the audio output devices 122, or the device 102 via the network device 116. In an example, the computing device 104 may communicate with the device 102 and/or the audio output devices 122 for offering data and/or services. For example, the computing device 104 may offer services such as network (e.g., Internet) connectivity, network printing, media management (e.g., a media server), interference management, content services, streaming services, broadband services, or other network-related services.

The computing device 104 may allow the user device 102 and/or the audio output devices 122 to interact with remote resources such as data, devices, and files. As an example, the computing device 104 may be configured as (or disposed at) a central location (e.g., a headend, or a processing facility), which can receive content (e.g., data, input programming) from multiple sources. The computing device 104 may be a separate/remote device from the headend, for example. The computing device 104 can combine content from the multiple sources and may distribute the content to user (e.g., subscriber) locations via a distribution system.

The computing device 104 may be configured to manage the communication between the device 102 and/or the audio output devices 122 and a storage system 114 (e.g., including a database 124) for sending and receiving data therebetween. As an example, the storage system 114 can store a plurality of files, user identifiers or records, or other information. As a further example, the device 102 and/or the audio output devices 122 may request and/or retrieve one or more files from the storage system 114. The storage system 114 may store information relating to the device 102 and/or the audio output devices 122 such as the address elements 110 and/or the service elements 112. As an example, the computing device 104 may obtain the device identifiers 108 and/or 118 from the device 102, the audio output devices 122, and/or the network device 116 and retrieve information from the storage system 114 such as the address elements 110 and/or the service elements 112. As a further example, the computing device 104 may obtain the address elements 110 from the device 102 and/or the audio output devices 122 and may retrieve the service elements 112 from the storage system 114, or vice versa. Any information can be stored in and retrieved from the storage system 114. The storage system 114 can be disposed remotely from the computing device 104 and accessed via direct or indirect connection. The storage system 114 can be integrated with the computing device 104 or some other device or system.

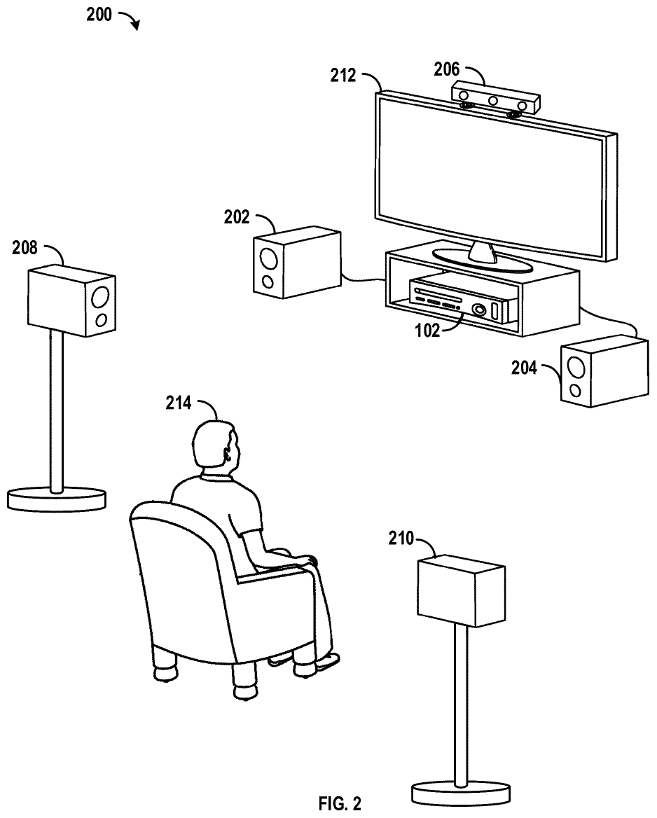

FIG. 2 shows an example configuration 200 of a plurality of plurality of audio output devices (e.g., audio output devices 122). The configuration 200 may include front audio output devices 202, 204, and 206 (e.g., a front left speaker, a front center speaker, and a front right speaker) and rear audio output devices 208 and 210 (e.g., a rear right speaker and a rear left speaker). The configuration may further include the device 102 (e.g., set top box, media player, etc.) and a display device 212 (e.g., television, smart TV, etc.). The device 102 may be configured to receive a content item associated with an audio playback profile. In an example, the content item may comprise first audio content and second audio content associated with video content. For example, the first audio content may comprise primary audio content of the content item and the second audio content may comprise one or more of secondary audio, supplemental audio, language audio, or descriptive audio of the content item. The audio playback profile may comprise one or more audio output device configurations for outputting the first audio content. As an example, the one or more audio output device configurations may be associated with multi-channel speaker formats such as (two channel) stereo (2.0), (four channel) Quattro (4.0), (four channel) LCRS, (six channel) 5.1, and (eight channel) 7.1 sound systems. As shown in FIG. 2, the device 102 may be associated with a five channel sound system comprising the front audio output devices 202, 204, and 206 and the rear audio output devices 208 and 210.

The device 102 may cause one or more audio output devices of the front audio output devices 202, 204, and 206 and the rear audio output devices 208 and 210 to output the first audio content based on the audio playback profile. In an example, the audio playback profile associated with the content item may comprise an audio output device configuration associated with a stereo 2.0 channel speaker format. Thus, the device 102 may only cause the front audio output devices 202 and 204 to output the first audio content. The device 102 may then determine that the front audio output device 206 and the rear audio output devices 208 and 210 are not outputting the first audio content. Based on the front audio output device 206 and the rear audio output devices 208 and 210 not outputting the first audio content, the device 102 may cause the front audio output device 206 and the rear audio output devices 208 and 210 to output the second audio content. In an example, the device 102 may cause the rear audio output devices 208 and 210 to output the second audio content based on one or more locations of a user 214 in the vicinity of the device 102. For example, the device 102 may determine that the user 214 is located closer to the rear right audio output device 210 and cause the rear right audio output device 210 to output the second audio content. In an example, the device 102 may balance the audio output (e.g., volume level) between the rear audio output devices 208 and 210 based on the user's 214. For example, the device 102 may cause the rear right audio output device 210 to output the second audio content at a lower volume level than the second audio content output by the rear left audio output device 208.

In an example, the audio playback profile associated with the content item may comprise an audio device configuration associated with a six channel 5.1 multi-channel speaker format. The device 102 may cause any audio output device of the front audio output devices 202, 204, and 206 and/or the rear audio output devices 208 and 210 to output the second audio content when not in use. For example, different audio output devices 202, 204, 206, 208, and 210 may output the first audio content depending on a scene/segment of the content item. The device 102 may determine when an audio output device 202, 204, 206, 208, and/or 210 is not in use, such as based on a scene/segment of the content item. For example, a scene/segment of a content item may be associated with audio content (e.g., the first audio content) being output from the front audio output devices 202, 204, and 206 while the rear audio output devices 208 and 210 are unused. Based on the rear audio output devices 208 and 210 being unused, the device 102 may cause the rear audio output devices 208 and 210 to output the second audio content. In an example, the device 102 may cause the unused audio output devices 202, 204, 206, 208, and/or 210 at, or based on, one or more time points in the content item to output the second audio content. In an example, the device 102 may cause one or more of the audio output devices 202, 204, 206, 208, and 210 that are being underutilized to output the first audio content. For example, the device 102 may determine that the front left audio output device 202 is being underutilized based on a state of audio output of the front left audio output device 202. The state of audio output may be associated with one or more of a frequency of use of an audio output device, a volume level of the first audio content being output, or an audio content type of the first audio content being output. The audio content type may comprise one or more of voice audio, background audio, foreground audio, or music audio. For example, the device 102 may determine that the front left audio output device 202 is not being used as often as the other front audio output devices 208 and 210 between scene/segments of the content item, is not outputting the first audio content at a threshold volume level, and/or is only being used for outputting background noise or music of the content item, and thus, is being underutilized. Based on the state of the front left audio output device 202 indicating that the front left audio output device 202 is being underutilized, the device 102 may also cause the front left audio output device 202 to output the second audio content (e.g., in addition to the first audio content).

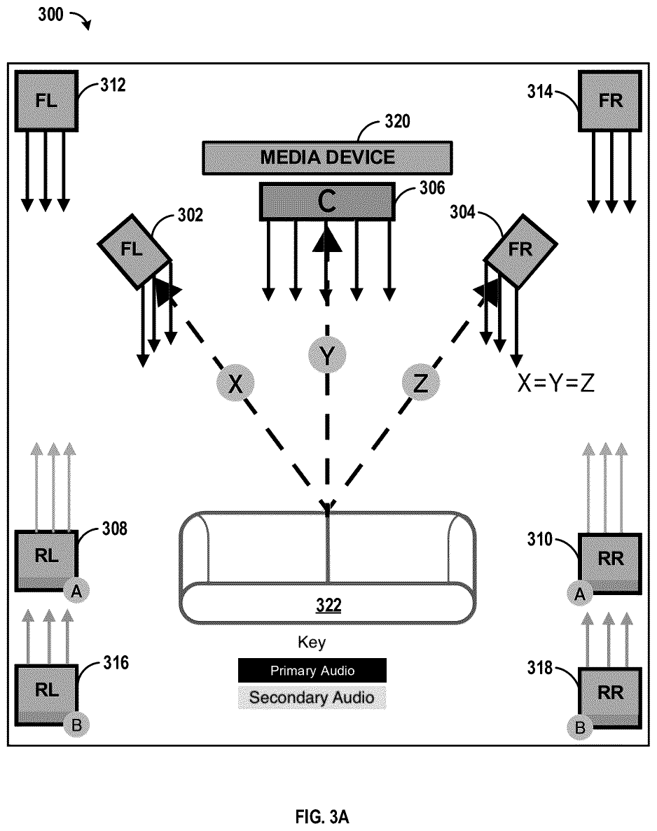

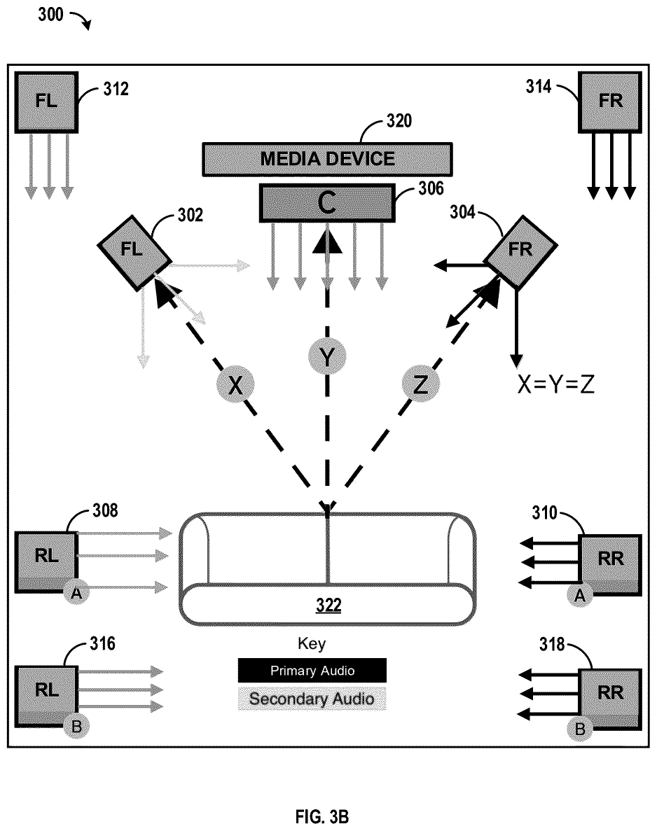

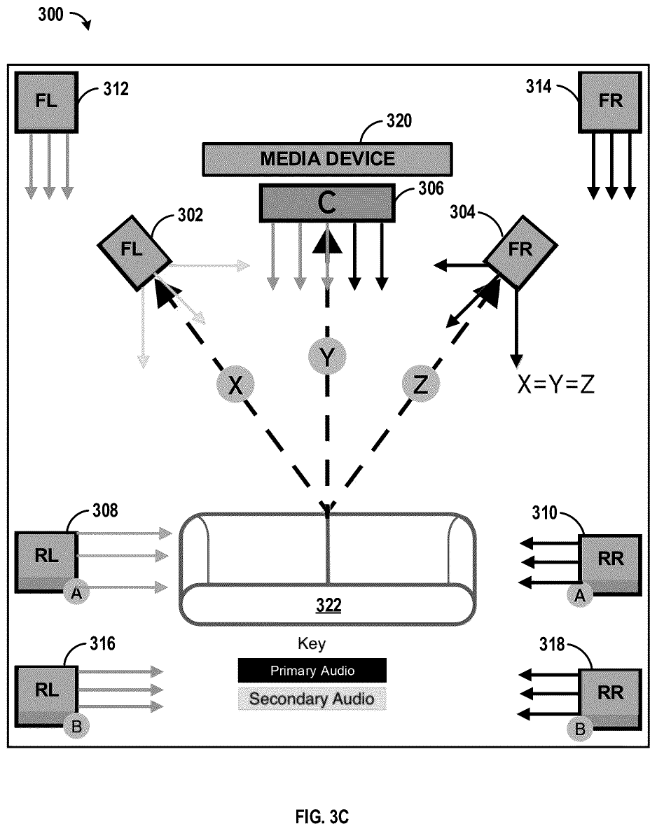

FIGS. 3A-3C show example scenarios of an example configuration 300 of a plurality of audio output devices (e.g., audio output devices 122). The configuration 300 may include front audio output devices 302, 304, 306, 312, and 314 (e.g., two front left speakers, a front center speaker, and two front right speakers) and rear audio output devices 308, 310, 316, and 318 (e.g., two rear right speakers and two rear left speakers). The configuration may further include a media device 320 (e.g., device 102, set top box, media player, display device, television, smart TV, etc.). The media device 320 may be configured to receive a content item associated with an audio playback profile. In an example, the content item may comprise first audio content and second audio content associated with video content. For example, the first audio content may comprise primary audio content of the content item and the second audio content may comprise one or more of secondary audio, supplemental audio, language audio, or descriptive audio of the content item. The audio playback profile may comprise one or more audio output device configurations for outputting the first audio content. As an example, the one or more audio output device configurations may be associated with multi-channel speaker formats such as (two channel) stereo (2.0), (four channel) Quattro (4.0), (four channel) LCRS, (six channel) 5.1, and (eight channel) 7.1 sound systems. As shown in FIGS. 3A-3C, the media device 320 may be associated with a 9 channel sound system comprising the front audio output devices 302, 304, 306, 312, and 314 and the rear audio output devices 308, 310, 316, and 318. The audio output devices 302, 304, 306, 308, 310, 312, 314, 316, and 318 may be configured to output the first and second audio content in one or more directions, as shown in FIGS. 3A-3C. FIG. 3A shows an example scenario wherein the media device 320 causes the front audio output devices 302, 304, 306, 312, and 314 to output the primary audio content (e.g., the first audio content) based on the audio playback profile. Based on determining that the rear audio output devices 308, 310, 316, and 318 are not outputting the first audio content, the media device 320 may cause the rear audio output devices 308, 310, 316, and 318 to output the secondary audio content (e.g., the second audio content). FIG. 3B shows an example scenario wherein the media device causes the right output devices 304, 310, 314, and 314 to output the primary audio content based on the audio playback profile. For example, based on a scene/segment of, or time point in, the content item, the primary audio content may be output to the right of the user 322. Based on determining that the left audio output devices 302, 308, 312, and 316 are not outputting the primary audio content, the media device 320 may cause the left audio output devices 302, 308, 312, and 316 to output the secondary audio content. In an example, the media device 320 may determine that the front center audio output device 306 is being underutilized based on a state of the audio output (e.g., state of the primary audio content being output) by the front center audio output device 306. The state of audio output may be associated with one or more of a frequency of use of an audio output device, a volume level of the first audio content being output, or an audio content type of the first audio content being output. The device 102 may determine that the front center output device 306 is not being used as often as the other front audio output devices 302, 304, 312, and 314 between scene/segments of the content item, is not outputting the first audio content at a threshold volume level, and/or is only being used for outputting foreground noise or music of the content item, and thus, is being underutilized. FIG. 3C shows an example scenario wherein the media device 320 may cause the center audio output device 306 to output both the first audio content and the second audio content based on the state of audio output of the front center audio output device 306 indicates that the front center audio output device 306 is being underutilized.

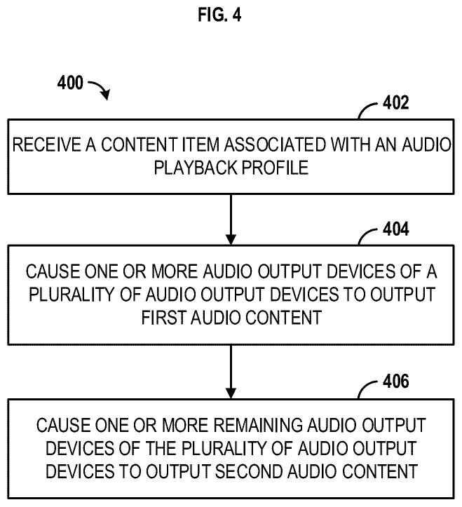

FIG. 4 shows a flowchart of an example method 400 for outputting audio content. Method 400 may be implemented, for example, by one or more media devices (e.g., device 102, set top box, media player, display device, television, smart TV, audio output devices 122, speakers, etc.). At step 402, a content item associated with an audio playback profile may be received. For example, a media device (e.g., device 102, set top box, media player, display device, television, smart TV, etc.) may receive the content item. The content item may comprise first audio content and second audio content. The audio playback profile may comprise one or more audio output device configurations for outputting the first audio content. As an example, the one or more audio output device configurations may be associated with multi-channel speaker formats such as (two channel) stereo (2.0), (four channel) Quattro (4.0), (four channel) LCRS, (six channel) 5.1, and (eight channel) 7.1 sound systems, including sound systems that include ceiling speakers, soundbars that bounce sound off of the ceiling (e.g., sound reverberation), etc. For example, the media device may cause left, center, and right front audio output devices, and left and right rear audio output devices to output the first audio content based on an audio playback profile indicating a six channel 5.1 multi-channel speaker format. The audio content may comprise primary audio of the content item and the second audio content may comprise one or more of secondary audio, supplemental audio, language audio, or descriptive audio of the content item.

At step 404, one or more audio output devices of a plurality of audio output devices may be caused to output the first audio content based on the audio playback profile. For example, the media device (e.g., device 102, set top box, media player, display device, television, smart TV, etc.) may cause the one or more audio output devices of the plurality of audio output devices to output the first audio content based on the audio playback profile. The plurality of audio output devices may comprise a plurality of speakers at one or more locations in a vicinity of the media device.

At step 406, one or more remaining audio output devices of the plurality of audio output devices may be caused to output the second audio content. For example, the media device (e.g., device 102, set top box, media player, display device, television, smart TV, etc.) may cause the one or more remaining audio output devices of the plurality of audio output devices to output the second audio content. The one or more remaining audio output devices may comprise one or more audio output devices of the plurality of audio output devices not outputting the first audio content. As an example, in a six channel 5.1 multi-channel speaker format, one or more of the audio output devices may not output audio content (e.g., first audio content), such as the rear audio output devices when there is no rear audio to be output to a user of the media device. The media device may determine that the rear audio output devices are not outputting the first audio content (e.g., during a scene or time point) and cause the rear audio output devices to output the second audio content. In an example, the one or more remaining audio output devices of the plurality of audio output devices may be caused to output the second audio content based on one or more locations of one or more users in a vicinity of the media device. For example, the media device may determine that the rear audio output devices are not outputting the first audio content (e.g., during a scene or time point). The media device may further determine (e.g., via one or more sensor devices) one or more locations of one or more users in the vicinity of the media device. For example, the media device may determine that a single user in the vicinity of the media device is located closer to the rear right audio output device and cause the rear right audio output device to output the second audio content. In an example, the media device may balance the audio output (e.g., volume level) between the rear audio output devices based on the user's location. For example, the media device may cause the rear right audio output device to output the second audio content at a lower volume level than the second audio content output by the rear left audio output device.

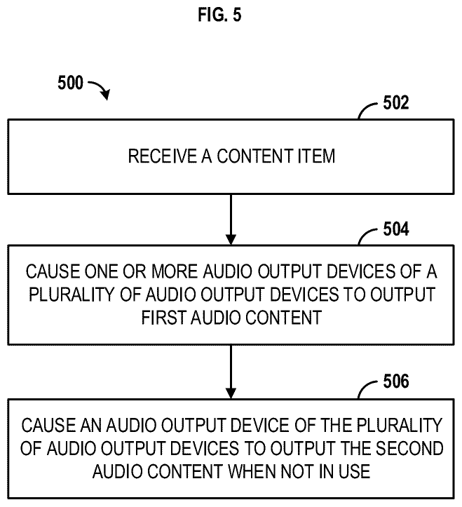

FIG. 5 shows a flowchart of an example method 500 for outputting audio content. Method 500 may be implemented, for example, by one or more media devices (e.g., device 102, set top box, media player, display device, television, smart TV, audio output devices 122, speakers, etc.). At step 502, a content item a may be received. For example, a media device (e.g., device 102, set top box, media player, display device, television, smart TV, etc.) may receive the content item. The content item may comprise first audio content and second audio content. The audio content may comprise primary audio of the content item and the second audio content may comprise one or more of secondary audio, supplemental audio, language audio, or descriptive audio of the content item.

At step 504, one or more audio output devices of a plurality of audio output devices may be caused to output the first audio content. For example, the media device (e.g., device 102, set top box, media player, display device, television, smart TV, etc.) may cause the one or more audio output devices of the plurality of audio output devices to output the first audio content. The plurality of audio output devices may comprise a plurality of speakers at one or more locations in a vicinity of the media device. In an example, the one or more audio output devices of the plurality of audio output devices may be caused to output the first audio content based on an audio playback profile associated with the content item. The audio playback profile may comprise one or more audio output device configurations for outputting the first audio content. As an example, the one or more audio output device configurations may be associated with multi-channel speaker formats such as (two channel) stereo (2.0), (four channel) Quattro (4.0), (four channel) LCRS, (six channel) 5.1, and (eight channel) 7.1 sound systems, including sound systems that include ceiling speakers, soundbars that bounce sound off of the ceiling (e.g., sound reverberation), etc. For example, the media device may cause left, center, and right front audio output devices, and left and right rear audio output devices to output the first audio content based on an audio playback profile indicating a six channel 5.1 multi-channel speaker format.

At step 506, an audio output device of the plurality of audio output devices may be caused to output the second audio content when not in use. For example, the media device (e.g., device 102, set top box, media player, display device, television, smart TV, etc.) may cause an audio output device of the plurality of audio output devices to output the second audio content when not in use. As an example, any audio output device of the plurality of audio output devices may be caused to output the second audio content when not in use. For example, different audio output devices may output the first audio content depending on a scene/segment of the content item. The media device may determine when an audio output device is not in use, such as based on a scene/segment of the content item. For example, a scene/segment of a content item may be associated with audio content (e.g., the first audio content) being output from one or more of the front audio output devices while the rear audio output devices are unused. Based on the rear audio output devices being unused, the media device may cause the rear audio output devices to output the second audio content.

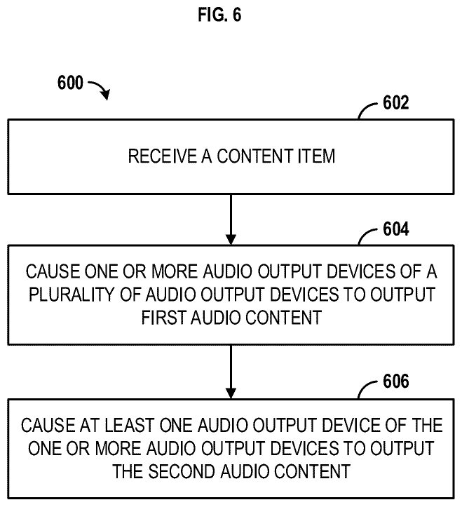

FIG. 6 shows a flowchart of an example method 600 for outputting audio content. Method 600 may be implemented, for example, by one or more media devices (e.g., device 102, set top box, media player, display device, television, smart TV, audio output devices 122, speakers, etc.). At step 602, a content item a may be received. For example, a media device (e.g., device 102, set top box, media player, display device, television, smart TV, etc.) may receive the content item. The content item may comprise first audio content and second audio content. The audio content may comprise primary audio of the content item and the second audio content may comprise one or more of secondary audio, supplemental audio, language audio, or descriptive audio of the content item.

At step 604, one or more audio output devices of a plurality of audio output devices may be caused to output the first audio content. For example, the media device (e.g., device 102, set top box, media player, display device, television, smart TV, etc.) may cause the one or more audio output devices of the plurality of audio output devices to output the first audio content. The plurality of audio output devices may comprise a plurality of speakers at one or more locations in a vicinity of the media device. In an example, the one or more audio output devices of the plurality of audio output devices may be caused to output the first audio content based on an audio playback profile associated with the content item. The audio playback profile may comprise one or more audio output device configurations for outputting the first audio content. As an example, the one or more audio output device configurations may be associated with multi-channel speaker formats such as (two channel) stereo (2.0), (four channel) Quattro (4.0), (four channel) LCRS, (six channel) 5.1, and (eight channel) 7.1 sound systems, including sound systems that include ceiling speakers, soundbars that bounce sound off of the ceiling (e.g., sound reverberation), etc. For example, the media device may cause left, center, and right front audio output devices, and left and right rear audio output devices to output the first audio content based on an audio playback profile indicating a six channel 5.1 multi-channel speaker format.

At step 606, at least one audio output device of the one or more audio output devices may be caused to output the second audio content based on a state of audio output indicating the at least one audio output device is being underutilized. For example, the media device (e.g., device 102, set top box, media player, display device, television, smart TV, etc.) may cause the at least one audio output device of the one or more audio output devices to output the second audio content based on the state of audio output indicating the at least one audio output device is being underutilized. The state of audio output may be associated with one or more of a frequency of use of an audio output device, a volume level of the first audio content being output, or an audio content type of the first audio content being output. The audio content type may comprise one or more of voice audio, background audio, foreground audio, or music audio. For example, the media device may determine that the front left audio output device is not being used as often as the other front audio output devices between scene/segments of the content item, is not outputting the first audio content at a threshold volume level, and/or is only outputting background noise or music of the content item, and thus, is being underutilized. Based on the state of the front left audio output device indicating that the front left audio output device is being underutilized, the media device may also cause the front left audio output device to output the second audio content (e.g., in addition to the first audio content). In an example, one or more remaining audio output devices of the plurality of audio output devices not outputting the first audio content may be caused to output the second audio content. For example, different audio output devices may output the first audio content depending on a scene/segment of the content item. The media device may determine when an audio output device is not outputting the first audio content, such as based on a scene/segment of the content item. For example, a scene/segment of a content item may be associated with audio content (e.g., the first audio content) being output from one or more of the front audio output devices while the rear audio output devices are not outputting the first audio content. Based on the rear audio output devices not outputting the first audio content, the media device may cause the rear audio output devices to output the second audio content.

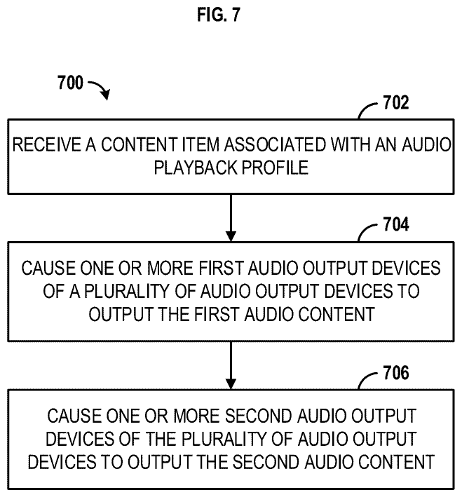

FIG. 7 shows a flowchart of an example method 700 for outputting audio content. Method 700 may be implemented, for example, by one or more media devices (e.g., device 102, set top box, media player, display device, television, smart TV, audio output devices 122, speakers, etc.). At step 702, a content item associated with an audio playback profile may be received. For example, a media device (e.g., device 102, set top box, media player, display device, television, smart TV, etc.) may receive the content item. The content item may comprise first audio content and second audio content. The audio playback profile may comprise one or more audio output device configurations for outputting the first audio content. As an example, the one or more audio output device configurations may be associated with multi-channel speaker formats such as (two channel) stereo (2.0), (four channel) Quattro (4.0), (four channel) LCRS, (six channel) 5.1, and (eight channel) 7.1 sound systems, including sound systems that include ceiling speakers, soundbars that bounce sound off of the ceiling (e.g., sound reverberation), etc. For example, the media device may cause left, center, and right front audio output devices, and left and right rear audio output devices to output the first audio content based on an audio playback profile indicating a six channel 5.1 multi-channel speaker format. The audio content may comprise primary audio of the content item and the second audio content may comprise one or more of secondary audio, supplemental audio, language audio, or descriptive audio of the content item.

At step 704, one or more first audio output devices of a plurality of audio output devices may be caused to output the first audio content based on the audio playback profile. For example, the media device (e.g., device 102, set top box, media player, display device, television, smart TV, etc.) may cause the one or more first audio output devices of the plurality of audio output devices to output the first audio content based on the audio playback profile. The plurality of audio output devices may comprise a plurality of speakers at one or more locations in a vicinity of the media device.

At step 706, one or more second audio output devices of the plurality of audio output devices may be caused to output the second audio content based on a user profile associated with the media device. For example, the media device (e.g., device 102, set top box, media player, display device, television, smart TV, etc.) may cause the one or more second audio output devices of the plurality of audio output devices to output the second audio content based on the user profile associated with the media device. For example, the media device may further include, or store, the user profile. The user profile may cause specific audio output devices to output the second audio content regardless of whether the audio output device is outputting the first audio content (e.g., based on one or more user preferences). For example, the user profile may be configured to override the audio playback profile to cause the one or more second audio output devices to output the second audio content regardless of whether the one or more second audio output devices are outputting the first audio content. In an example, the rear audio output devices may output the first audio content during certain scenes/segments of the content item. However, the user profile may require that the rear audio output devices (e.g., since the rear speakers are usually the closest to the user) always output the second audio content. The media device may cause the rear audio output devices to output both the first audio content and the second audio content based on the user profile. In an example, the media device may balance the audio output (e.g., volume of the first audio content and/or the second audio content) at the rear audio output devices. For example, the media device may cause the rear audio output devices to output the first audio content at a lower volume level than the second audio content. In an example, the one or more second audio output devices may further include at least one first audio output device of the one or more first audio output devices.

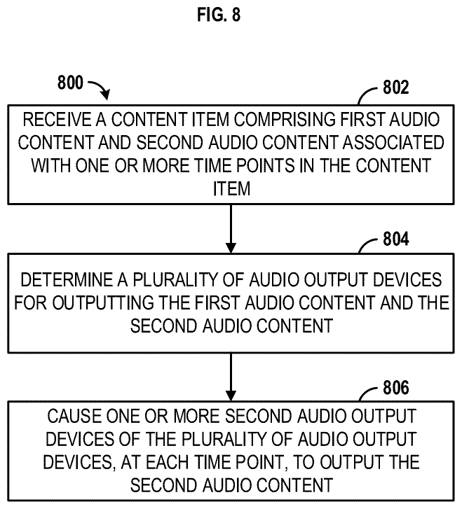

FIG. 8 shows a flowchart of an example method 800 for outputting audio content. Method 800 may be implemented, for example, by one or more media devices (e.g., device 102, set top box, media player, display device, television, smart TV, audio output devices 122, speakers, etc.). At step 802, a content item comprising first audio content and second audio content associated with one or more time points in the content item may be received. For example, a media device (e.g., device 102, set top box, media player, display device, television, smart TV, etc.) may receive the content item comprising the first audio content and the second audio content associated with the one or more time points in the content item. The first audio content may comprise primary audio of the content item and the second audio content may comprise one or more of secondary audio, supplemental audio, language audio, or descriptive audio of the content item.

At step 804, a plurality of audio output devices for outputting the first audio content and the second audio content may be determined. For example, the media device (e.g., device 102, set top box, media player, display device, television, smart TV, etc.) may determine the plurality of audio output devices for outputting the first audio content and the second audio content. For example, the media device may be in communication with front audio output devices (e.g., a center, a front right speaker, a front left speaker, a ceiling speaker, a sub-woofer, a reverberating speaker, etc.) and rear audio output devices (e.g., rear a rear right speaker, a rear left speaker, etc.) for outputting the first audio content and the second audio content.

At step 806, one or more second audio output devices of the plurality of audio output devices may be caused to output the second audio content at each time point based on one or more first audio output devices of the plurality of audio output devices for outputting the first audio content at each time point of the one or more time points. For example, the media device (e.g., device 102, set top box, media player, display device, television, smart TV, etc.) may cause the one or more second audio output devices of the plurality of audio output devices to output the second audio content at each time point based on the one or more first audio output devices of the plurality of audio output devices for outputting the first audio content at each time point of the one or more time points. In an example, the one or more second audio output devices may comprise one or more audio output devices of the plurality of audio output devices not outputting the first audio content at each time point (e.g., remaining audio output devices not outputting the first audio content). In an example, the one or more second audio output devices of the plurality of audio output devices may be caused to output the second audio content at each time point based on a state of each first audio output device of the one or more first audio output devices outputting the first audio content at each time point. The state of each first audio output device may be associated with one or more of a frequency of use of an audio output device, a volume level of the first audio content being output, or an audio content type of the first audio content being output. The audio content type may comprise one or more of voice audio, background audio, foreground audio, or music audio. For example, the media device may determine that the front left audio output device is not being used as often as the other front audio output devices between scene/segments of the content item, is not outputting the first audio content at a threshold volume level, and/or is only outputting background noise or music of the content item, and thus, is being underutilized. Based on the state of the front left audio output device indicating that the front left audio output device is being underutilized, the media device may also cause the front left audio output device to output the second audio content (e.g., in addition to the first audio content).

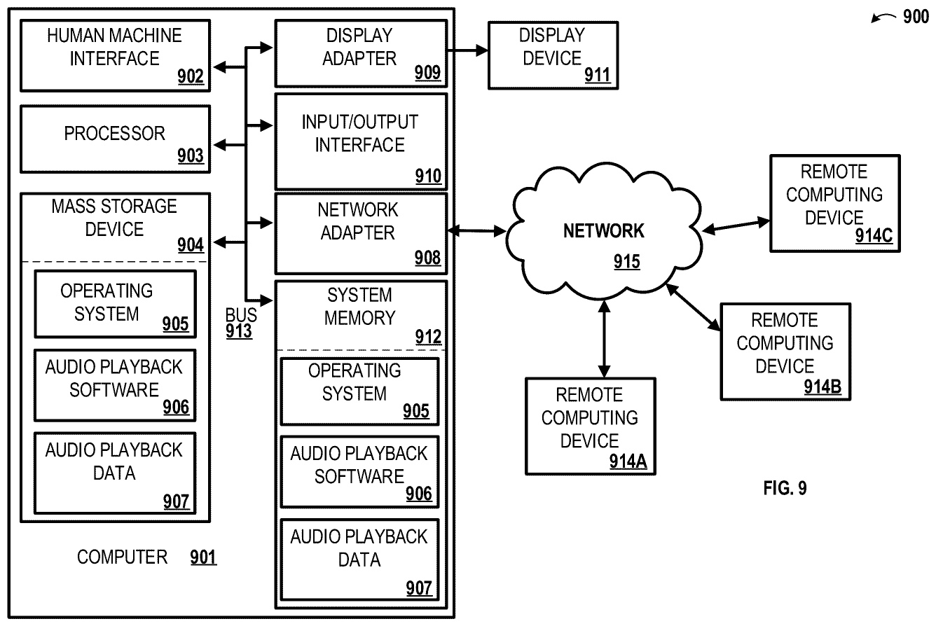

FIG. 9 is a block diagram illustrating an example computing device. The methods and systems can be implemented on a computer 901 as illustrated in FIG. 9 and described below. By way of example, user device 102A-102B, the network devices 116A-116B, and computing device 104 of FIG. 1 can be a computer 901 as illustrated in FIG. 9. Similarly, the methods and systems disclosed can utilize one or more computers to perform one or more functions in one or more locations. FIG. 9 is a block diagram illustrating an exemplary operating environment 900 for performing the disclosed methods. This exemplary operating environment 900 is only an example of an operating environment and is not intended to suggest any limitation as to the scope of use or functionality of operating environment architecture. Neither should the operating environment 900 be interpreted as having any dependency or requirement relating to any one or combination of components illustrated in the exemplary operating environment 900.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media including memory storage devices.

Further, one skilled in the art will appreciate that the systems and methods disclosed herein can be implemented via a general-purpose computing device in the form of a computer 901. The computer 901 can comprise one or more components, such as one or more processors 903, a system memory 912, and a bus 913 that couples various components of the computer 901 including the one or more processors 903 to the system memory 912. In the case of multiple processors 903, the system can utilize parallel computing.

The bus 913 can comprise one or more of several possible types of bus structures, such as a memory bus, memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 913, and all buses specified in this description can also be implemented over a wired or wireless network connection and one or more of the components of the computer 901, such as the one or more processors 903, a mass storage device 904, an operating system 905, audio playback software 906, audio playback data 907, a network adapter 908, system memory 912, an Input/Output Interface 910, a display adapter 909, a display device 911, and a human machine interface 902, can be contained within one or more remote computing devices 914A-914C at physically separate locations, connected through buses of this form, in effect implementing a fully distributed system.

The computer 901 typically comprises a variety of computer readable media. Exemplary readable media can be any available media that is accessible by the computer 901 and comprises, for example and not meant to be limiting, both volatile and non-volatile media, removable and non-removable media. The system memory 912 can comprise computer readable media in the form of volatile memory, such as random access memory (RAM), and/or non-volatile memory, such as read only memory (ROM). The system memory 912 typically can comprise data such as audio playback data 907 and/or program modules such as operating system 905 and audio playback software 906 that are accessible to and/or are operated on by the one or more processors 903.

The computer 901 can also comprise other removable/non-removable, volatile/non-volatile computer storage media. By way of example, the computer 901 can comprise a mass storage device 904 which can offer non-volatile storage of computer code, computer readable instructions, data structures, program modules, and other data for the computer 901. For example, a mass storage device 904 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 904, including by way of example, an operating system 905 and audio playback software 906. One or more of the operating system 905 and audio playback software 906 (or some combination thereof) can comprise elements of the programming and the audio playback software 906. Audio playback data 907 can also be stored on the mass storage device 904. Audio playback data 907 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 915.

The user can enter commands and information into the computer 901 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 903 via a human machine interface 902 that is coupled to the bus 913, but can be connected by other interface and bus structures, such as a parallel port, game port, an IEEE 1394 Port (also known as a Firewire port), a serial port, network adapter 908, and/or a universal serial bus (USB).

A display device 911 can also be connected to the bus 913 via an interface, such as a display adapter 909. It is contemplated that the computer 901 can have more than one display adapter 909 and the computer 901 can have more than one display device 911. For example, a display device 911 can be a monitor, an LCD (Liquid Crystal Display), light emitting diode (LED) display, television, smart lens, smart glass, and/or a projector. In addition to the display device 911, other output peripheral devices can comprise components such as speakers (not shown) and a printer (not shown) which can be connected to the computer 901 via Input/Output Interface 910. Any step and/or result of the methods can be output in any form to an output device. Such output can be any form of visual representation, including, but not limited to, textual, graphical, animation, audio, tactile, and the like. The display 911 and computer 901 can be part of one device, or separate devices.

The computer 901 can operate in a networked environment using logical connections to one or more remote computing devices 914A, 914B, and 914C. By way of example, a remote computing device 914A-914C can be a personal computer, a computing station (e.g., a workstation), a portable computer (e.g., a laptop, a mobile phone, a tablet device), a smart device (e.g., a smartphone, a smart watch, an activity tracker, a smart apparel, a smart accessory), a security and/or monitoring device, a server, a router, a network computer, a peer device, an edge device or other common network node, and so on. Logical connections between the computer 901 and a remote computing device 914A-914C can be made via a network 915, such as a local area network (LAN) and/or a general wide area network (WAN). Such network connections can be through a network adapter 908. A network adapter 908 can be implemented in both wired and wireless environments. Such networking environments are conventional and commonplace in dwellings, offices, enterprise-wide computer networks, intranets, and the Internet.

For purposes of illustration, application programs and other executable program components such as the operating system 905 are illustrated herein as discrete blocks, although it is recognized that such programs and components can reside at various times in different storage components of the computer 901, and are executed by the one or more processors 903 of the computer 901. An implementation of audio playback software 906 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g., a genetic algorithms), swarm intelligence (e.g., an ant algorithms), and hybrid intelligent systems (e.g., expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
receiving, by a media device, a content item associated with an audio playback profile, wherein the content item comprises first audio content and second audio content;
causing, based on the audio playback profile, one or more audio output devices of a plurality of audio output devices to output the first audio content; and
causing one or more remaining audio output devices of the plurality of audio output devices to output the second audio content.

2. The method of claim 1, wherein the media device comprises a display device for outputting video content of the content item.

3. The method of claim 1, wherein the audio playback profile comprises one or more audio output device configurations for outputting the first audio content.

4. The method of claim 1, wherein the first audio content comprises primary audio of the content item and the second audio content comprises one or more of secondary audio, supplemental audio, language audio, or descriptive audio of the content item.

5. The method of claim 1, wherein the plurality of audio output devices comprises a plurality of speakers at one or more locations in a vicinity of the media device.

6. The method of claim 1, wherein the one or more remaining audio output devices comprise one or more audio output devices of the plurality of audio output devices not outputting the first audio content.

7. The method of claim 1, wherein causing the one or more remaining audio output devices of the plurality of audio output devices to output the second audio content comprises causing, based on one or more locations of one or more users in a vicinity of the media device, the one or more remaining audio output devices of the plurality of audio output devices to output the second audio content.

8. A method comprising:
receiving, by a media device, a content item, wherein the content item comprises first audio content and second audio content;
causing one or more audio output devices of a plurality of audio output devices to output the first audio content; and
causing an audio output device of the plurality of audio output devices to output the second audio content when not in use.

9. The method of claim 8, wherein the media device comprises a display device for outputting video content of the content item and the plurality of audio output devices comprises a plurality of speakers at one or more locations in a vicinity of the media device.

10. The method of claim 8, wherein causing the one or more audio output devices of the plurality of audio output devices to output the first audio content comprises causing, based on an audio playback profile associated with the content item, the one or more audio output devices of the plurality of audio output devices to output the first audio content.

11. The method of claim 10, wherein the audio playback profile comprises one or more audio output device configurations for outputting the first audio content.

12. The method of claim 8, wherein the first audio content comprises primary audio of the content item and the second audio content comprises one or more of secondary audio, supplemental audio, language audio, or descriptive audio of the content item.

13. A method comprising:
receiving, by a media device, a content item, wherein the content item comprises first audio content and second audio content;
causing one or more audio output devices of a plurality of audio output devices to output the first audio content; and
causing, based on a state of audio output indicating at least one audio output device of the one or more audio output devices is being underutilized, the at least one audio output device to output the second audio content.

14. The method of claim 13, wherein the media device comprises a display device for outputting video content of the content item and the plurality of audio output devices comprises a plurality of speakers at one or more locations in a vicinity of the media device.

15. The method of claim 13, wherein causing the one or more audio output devices of the plurality of audio output devices to output the first audio content comprises causing, based on an audio playback profile associated with the content item, the one or more audio output devices of the plurality of audio output devices to output the first audio content.

16. The method of claim 15, wherein the audio playback profile comprises one or more audio output device configurations for outputting the first audio content.

17. The method of claim 13, wherein the first audio content comprises primary audio of the content item and the second audio content comprises one or more of secondary audio, supplemental audio, language audio, or descriptive audio of the content item.

18. The method of claim 13, wherein the state of audio output is associated with one or more of a frequency of use of an audio output device, a volume level of the first audio content being output, or an audio content type of the first audio content being output.

19. The method of claim 18, wherein the audio content type comprises one or more of voice audio, background audio, foreground audio, or music audio.

20. The method of claim 13, further comprising causing one or more remaining audio output devices of the plurality of audio output devices not outputting the first audio content to output the second audio content.
